(19) United States
(12) Patent Application Publication
(10) Pub. No.: US 2023/0124605 A1
(43) Pub. Date: Apr. 20, 2023

(54) PROJECT TIME TRACKER

(71) Applicant: DMS MANAGEMENT GROUP OF PR, LLC, Guaynabo, PR (US)

(72) Inventor: David Schmitt, Guaynabo, PR (US)

(21) Appl. No.: 17/502,195

(22) Filed: Oct. 15, 2021

(51) Int. Cl. G06Q 10/06; G06Q 10/10; H04W 4/021

(52) U.S. Cl. CPC G06Q 10/063114; G06Q 10/1091; H04W 4/021

(57) ABSTRACT

Systems and methods for monitoring or verifying worker activity while in a commercial or business setting. The systems and methods for monitoring workers may be configured to track, verify or confirm one or more employee activities related to employment duties, such as being at the location of business for the times the employee reports to be working and for which the employee expects to receive payment for services rendered.

### FIELD OF THE INVENTION

Embodiments of the present invention relate to systems and methods that electronically track employees; more particularly, to systems and methods for verifying, monitoring, information gathering, and data processing of one or more activities of employees while at a work site or within a commercial or business setting.

### BACKGROUND OF THE INVENTION

Businesses of all types require employees to handle day to day operations. Ensuring their employees are on site and working properly is critical to the company's profits or funding. The typical mechanism for tracking workers at a work site or commercial setting is the use of some type of time tracking mechanism. In days past, such systems might include the use of time cards, where each employee stamps his/her card upon entering and leaving a job site. In this manner, an employer can track the number of hours each employee is on the job. In more modern times, the use of time cards and time stamps have been replaced by use of electronic cards. In this case, a worker's ID badge may be used to electronically track when he/she enters or leaves their job site. While such systems are useful in tracking employee on the job working hours, such systems have their problems.

One of the biggest issues an employer may face is employee theft. While most people think of this as being related to stealing products or office supplies, stealing “time” can result in tremendous loss and inefficacies for companies. Such time loss may be the result of employees reporting that they are on a job site and working, but in reality they are not. For companies using standard time tracking mechanisms, whether using the stamped time cards or electronic identification cards, the risk of fraud remains, as these systems can be easily manipulated. For example, employees can have other employees “check” them in/out. Even in situations where the employee is not acting with malice, i.e. the employees may forget to or improperly checks in/out, or their electronic cards are not working, time loss results as it requires time and effort to correct this so each employee gets paid properly to avoid any legal liabilities. In addition, current time tracking mechanisms simply track an individual's time on or off the work site. Companies may need to track other employee related activities of their employees while working each day.

### SUMMARY OF THE INVENTION

Embodiments of the invention provide systems and methods that track one or more activities of employees, or contractors, while on a work site. Accordingly, an illustrative embodiment of the invention provides a method of electronically verifying and tracking one or more activities of an individual within a worksite, comprising: establishing an electronic connection with an electronic tracking device used by an individual requiring verification and tracking within a worksite; identifying said individual requiring verification and tracking within a worksite; verifying said individual requiring verification and tracking is located at or within a predetermined area near said worksite; verifying an identity of said individual requiring verification and tracking; and obtaining data related to at least one or more employment activities of said individual requiring verification and tracking within a worksite while located at or within a predetermined area near said worksite.

Another illustrative embodiment of the invention provides a non-transitory computer readable medium having computer readable instructions embodied thereon for electronically verifying and tracking one or more activities of an individual within a worksite, wherein, when executed by at least one processor of an electronic tracking device used by said individual requiring verification and tracking within a worksite, the computer-executable instructions cause at least one processor to at least perform operations comprising: establishing an electronic connection with an electronic tracking device used by an individual requiring verification and tracking within a worksite; identifying said individual requiring verification and tracking within a worksite; verifying said individual requiring verification and tracking is located at or within a predetermined area near said worksite; verifying an identity of said individual requiring verification and tracking; and obtaining data related to at least one or more employment activities of said individual requiring verification and tracking within a worksite while located at or within a predetermined area near said worksite.

Another illustrative embodiment of the invention provides a system for electronically verifying and tracking one or more activities of an individual within a worksite comprising an electronic device, a processor operable to execute instructions, and a data storage medium for storing instructions which, when executed by the processor, cause the processor to: identify said individual requiring verification and tracking within a worksite; verify said individual requiring verification and tracking is located at or within a predetermined area near said worksite; verify an identity of said individual requiring verification and tracking; and obtain data related to at least one or more employment activities of said individual requiring verification and tracking within a worksite while located at or within a predetermined area near said worksite.

Accordingly, it is an objective of an embodiment of the invention to provide systems and methods that track one or more activities of employees while on a work site.

It is a further objective of an embodiment of the invention to provide systems and methods that verify and track one or more activities of employees while on a work site.

It is yet another objective of an embodiment of the invention to provide a system which is configured to use a geofence for verification that a user/employee is at or within a predetermined area near said worksite.

It is a still further objective of an embodiment of the invention to provide a method which is configured to use a geofence for verification that a user/employee is at or within a predetermined area near said worksite.

It is a further objective of an embodiment of the invention to provide a system which is configured to use facial recognition to verify the user/employee.

It is yet another objective of an embodiment of the invention to provide a method which is configured to use facial recognition to verify the user/employee.

It is a still further objective of an embodiment of the invention to provide a system which is configured to obtain data relating to one or more employment related activities associated with a user/employee while on a worksite performing a job.

It is a further objective of an embodiment of the invention to provide a method which is configured to obtain data relating to one or more employment related activities associated with a user/employee while on a worksite performing a job.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1A is an illustrative example of a system for monitoring workers while in a commercial or business setting;

FIG. 1B is an illustrative example of a method for monitoring workers while in a commercial or business setting;

FIG. 2 is an illustrative example of a screen shot associated with a system and method for monitoring workers while in a commercial or business setting, illustrating a login-screen;

FIG. 3 is an illustrative example of a project list screen shot;

FIG. 4 is an illustrative example of a zoomed-in view of a job site location screen shot;

FIG. 5 is an illustrative example of a menu screen shot;

FIG. 6 is an illustrative example of a Select Project screen shot;

FIG. 7 is an illustrative example of an alternative Select Project screen shot;

FIG. 8 is an illustrative example of an employee list screen shot;

FIG. 9 is an illustrative example of a facial recognition screen shot;

FIG. 10 is an illustrative example of an alternative facial recognition screen shot;

FIG. 11 is an illustrative example of a registration confirmation screen shot;

FIG. 12 is an illustrative example of an attendance screen shot;

FIG. 13 is an illustrative example of a clock-out screen shot;

FIG. 14 is an illustrative example of a first employment related activities screen shot;

FIG. 15 is an illustrative example of a second employment related activities screen shot;

FIG. 16 is an illustrative example of a third employment related activities screen shot;

FIG. 17 is an illustrative example of a message box screen shot;

FIG. 18 is an illustrative example of a clock-out confirmation screen shot;

FIG. 19 is an illustrative example of a budget screen shot;

FIG. 20 is an illustrate example of a screen shot pf a data dashboard in preparation for downloading data relating to worker clock-in/clock-out times per payroll-cycle; and

FIG. 21 is an illustrative example of an employee registration screen shot.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Embodiments of the invention discussed herein are directed to systems and methods for monitoring workers while in a commercial or business setting. The systems and methods for monitoring workers may be configured to track and/or verify or confirm one or more employee activities related to employment duties, such as being at the location of business for the times the user/employee reports to be working and for which he/she expects to receive payment for the job performed. In an illustrative embodiment, the systems and methods allow a business owner or management to collect and process data relating to employee attendance, job productivity, and confirmation of occurrence of employee work day related activities. The systems and methods are designed to prevent or minimize losses in revenues resulting from employee activity or inactivity. In addition, the systems and methods are designed to allow employees to more easily and accurately report on the number or percentage of job hours completed, and other job-related activities.

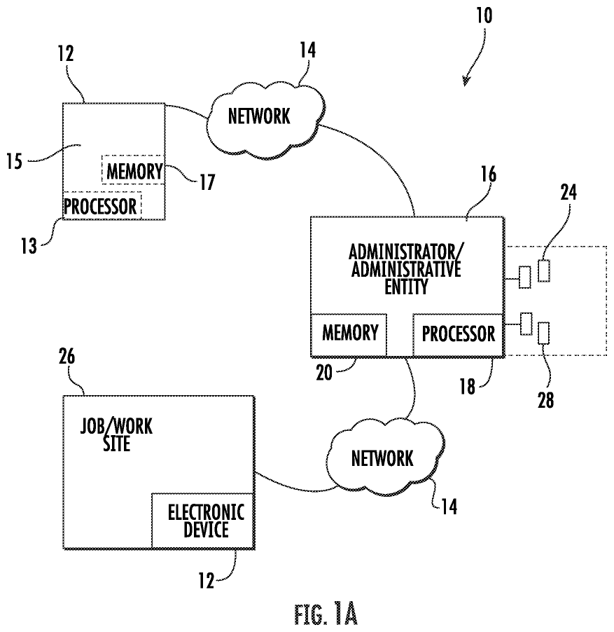

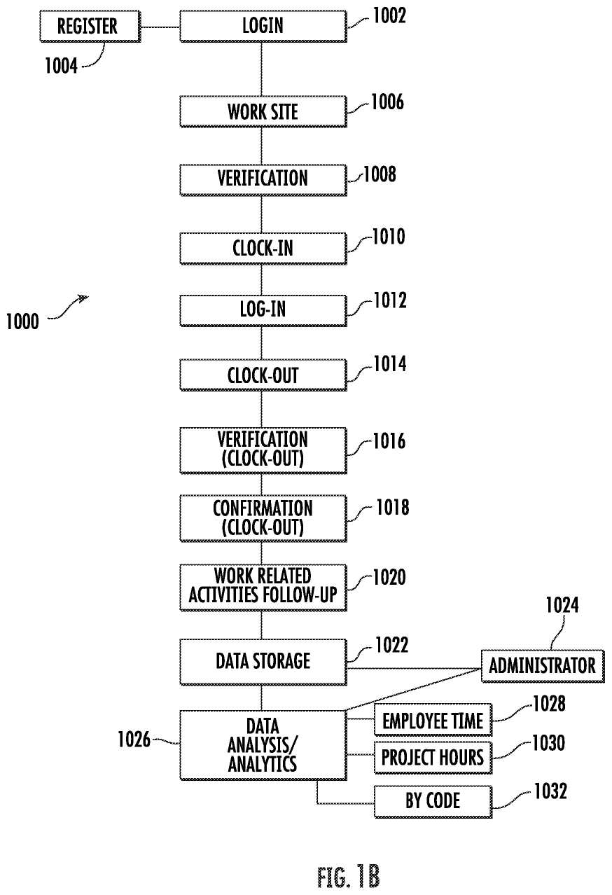

FIG. 1A provides an illustrative embodiment of a system for monitoring workers while in a commercial or business setting, referred to herein as an employee tracking system 10. The employee tracking system 10 may comprise one or more, in any combination, of each component as described herein. The employee tracking system 10 includes tracking and data collection device(s) 12 for each individual employee. The employee tracking and data collection device 12 may be an electronic device, such as a smart device, such as a phone or tablet computer, such as an IPAD. The electronic device(s) may include an electronic device having the necessary software and/or hardware to drive or provide functionality, including having at least a processor 13 operable to execute instructions and a data storage medium for storing instructions which, when executed by the processor 13, cause the processor to perform one or more functions, and/or a display screen 15 for displaying an image, which may be used or form part of the system. Memory 17 may include, for example, RAM (random access memory) or ROM (read only memory); or for cell phones, built in memory or memory SD memory card. The employee tracking and data collection device 12 may be configured to communicate via the internet 14, or other conventional communication networks, such as wireless technology, such as BLUETOOTH® technology, RFID, or WIFI technology, cell phone networks (CDMA or GSM), satellite networks, or broadband networks, with an administrator/administration entity 16. The employee tracking and data collection device(s) 12 may be configured for GPS technology and have GPS receivers or transmitters.

The administrator/administration entity 16 is configured to receive, store, and process any data received from the employee tracking and data collection devices 12. Accordingly, the administrator/administration entity 16 may include one or more electronic devices having the necessary software and/or hardware to drive or provide functionality, including having at least a processor 18, memory 20 operable to execute instructions, and a data storage medium for storing instructions, which, when executed by the processor, cause the processor to perform one or more functions. The memory 20 may include, for example, RAM (random access memory) or ROM (read only memory). The data storage may include a database 24 which is configured to store historical information, such as employee names and contact information, or a list of work/job sites or business sites 26 to be monitored. A second database 28 may include storing “live” information, i.e. information received from each employee tracking and data collection device 12. While the two databases 24 and 28 are illustrated as separate databases, they may be configured as a single database.

The work/job site or business site 26 may be any type of area that requires tracking of an employee. While the description of embodiments of the invention which follow describe job site related to construction, such work site is exemplary only. Other work/job sites or business sites may be, for example, a restaurant, a grocery store, an accounting office, or a big-box retail store like WALMART or COSTCO. Each work/job site or business site 26 may be configured to provide one or more employee tracking and data collection devices 12. Accordingly, rather than each individual employee carrying his/her own cellphone, the work/job sites or business sites 26 may utilize its' own electronic device(s), such as a computer, that each employee logs in and uses each day.

FIG. 1B provides an illustrative embodiment of a method for monitoring workers while in a commercial or business setting, referred to herein as an employee tracking method 1000. The employee tracking method 1000 provides a method for tracking employee work related activities within a work/job site. The employee tracking method 1000 may begin with a user/employee using an electronic device to login, see 1002. If the user/employee has not used the employee tracking method 1000 before, he/she may be required to register as a user, 1004. Registration 1004 may require input of contact information, such as user/employee name, password, and/or obtaining or taking a picture of the user/employee. Once logged in, the user/employee will be required to choose a worksite location, 1006. Alternatively, prior to logging in, the user/employee may receive a text message which allows user/employee access to a particular job site. In a preferred embodiment, a geofence is established or created relative to the work/job site, preferably by the administrator/administration entity 16. As used herein, the term “geofence” may be defined as a virtual geographic boundry, defined for example by GPS or RFID technology that enables software to trigger a response when an electronic device, such as a mobile device, enters or leaves a particular area. The geofence is a virtual perimeter for a real world geographical area, i.e. the work site. The geofence may be dynamically generated (as in a radius around a point location) or match a predefined set of boundaries (such as a worksite or neighborhood). As long as the user/employee is located within the geofence area, he/she will be allowed to continue with the process.

Once the correct work/job site is determined or selected, a verification process 1008 is used. The verification process 1008 is designed to ensure and/or determine that the user/employee is the actual user/employee trying to clock-in. Accordingly, the verification process 1008 is configured to prevent or minimize fraud, such as having a co-worker check-in or clock-out for the actual user/employee. In an illustrative embodiment, the user/employee, after being confirmed that he/she is located within the geofenced area associated with the work/jobsite, would be required to take a picture, in real time, right on site. The just taken picture would then be compared to a picture on file or in a database to ensure that person is who he/she is claiming to be.

Once verified, the user/employee clocks-in, 1010, this providing an electronic record or stamp indicating when the user/employee begins work at the particular job/worksite. When the user/employee has completed his/her work shift, the user/employee may log back in, 1012, and begin the clock-out process, 1014. A clock-out verification process 1016 may be required to ensure and/or determine that the user/employee is the actual user/employee trying to clock-in or clock-out. In an illustrative embodiment, the user/employee would be required to take a picture, in real time, on site. The just taken picture would then be compared to a picture on file to ensure that person is who he/she is claiming to be. A clock-out confirmation 1018 may be generated and sent to the user/employee. After clocking out, additional employment activities may be documented, stored, and tracked, 1020. In this step, the user/employee may be asked one or more questions related to activities relevant to the job.

All data collected may be stored on the individual tracking and data collection devices 12, see 1022. Alternatively, or in addition, data collected may be sent and/or stored to the administrator/administrative entity 16, see step 1024, or other third party entities. The data collected on each user/employee can be analyzed by the business owner or management team, and may include employee work time or hours, 1028, project hours, 1030, or data sorted by codes representing various jobs or activities, 1032.

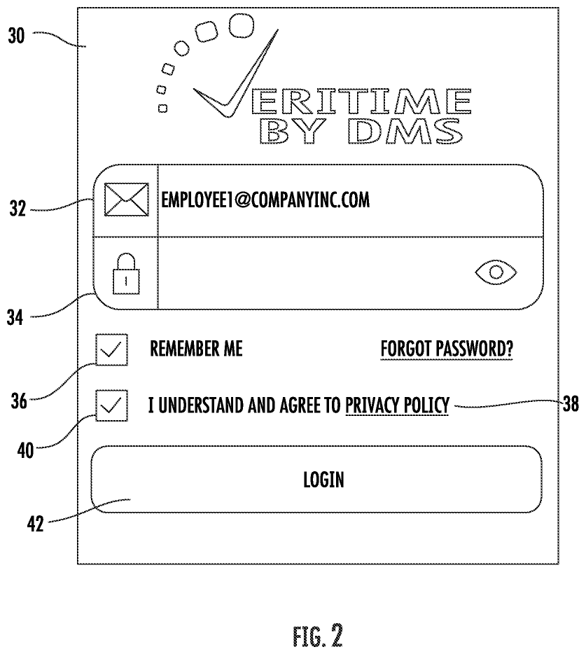

Referring to FIGS. 2-20, examples of screen shots associated with the tracking and data collection devices 12 are shown. In use, a user, i.e. an employee, or any other person, such as a contractor, for which one or more activities require tracking, uses his/her tracking and data collection device 12 to initiate the tracking process. In an illustrative embodiment, the user is using his/her cell phone as the data collection device 12 and is login in to record hours and employee activities at a construction site. FIG. 2 illustrates a login screen shot 30 accessed on the user/employee's cell phone. The user/employee may be prompted to type in login information, such as an email address 32 and password 34. The login-screen shot 30 may also allow a user/employee to check a box 36, thus saving their information to allow the user/employee to skip manually entering the email address and password thereafter when he/she clicks on the software application on their phone. The login-screen shot 30 may also allow the user to view the company's privacy policy 38 and check a box 40 to indicate they have done so. Once the user/employee enters their email address and password, they may click on the “LOGIN” box 42 to move on in the process.

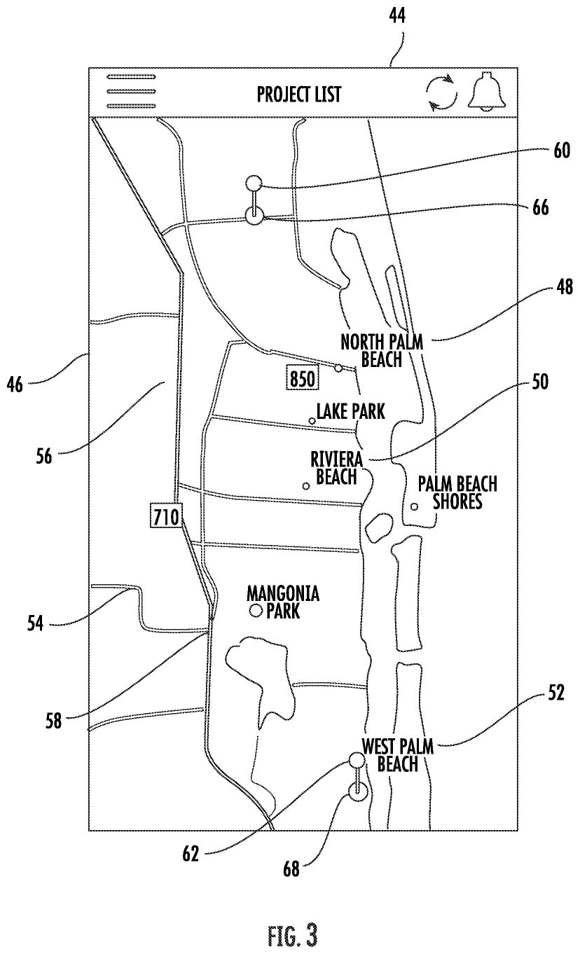

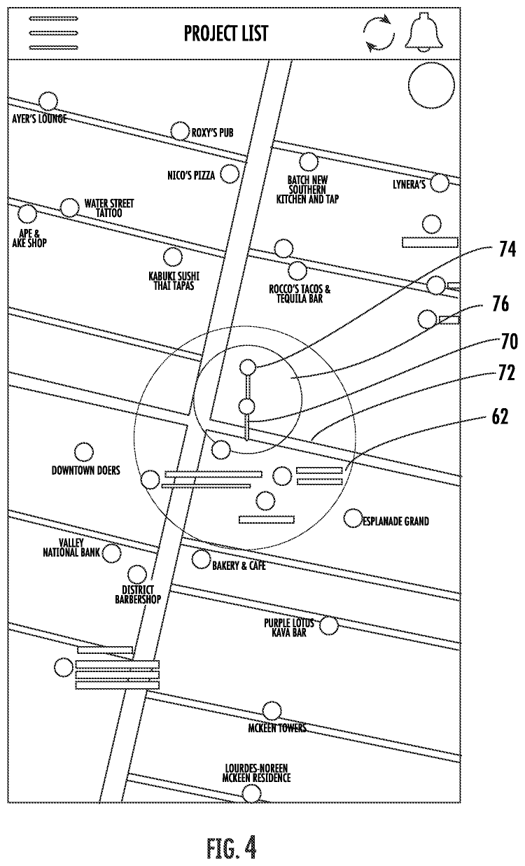

Once logged in, the user/employee is then taken to a “Project List” screen shot 44, see FIG. 3. From here, the user may select a job site location for which tracking is required. Accordingly, a user/employee is presented with a map 46 showing one or more towns or cities, such as North Palm Beach, Florida, 48, Riviera Beach, Florida, 50, or West Palm Beach, Florida 52. The map 46 may also include roads, such as 45th Street, 54, or Northlake, 56, and a highway, such as Interstate-95, 58. Such features allow a user/employee to easily identify or find a particular job site. As illustrated on the map 46, two job site locations are shown, worksite no. 1, 60, and worksite no. 2, 62. Each job site location, 60 and 62, represent associated project geofences, 66 and 68, in the illustrated area. FIG. 4 illustrates a zoomed-in view of job site location 62. In this view, a user/employee can view various job-site projects and associated geofences that they are located in and eligible to clock into. As shown, the user/employee may choose between two projects, worksite project 70 with associated geofence 72, and a second worksite project 74 with associated geofence 76.

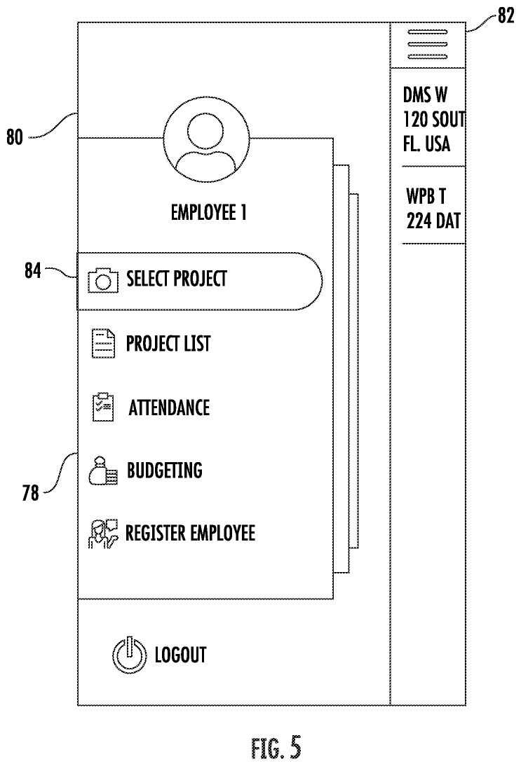

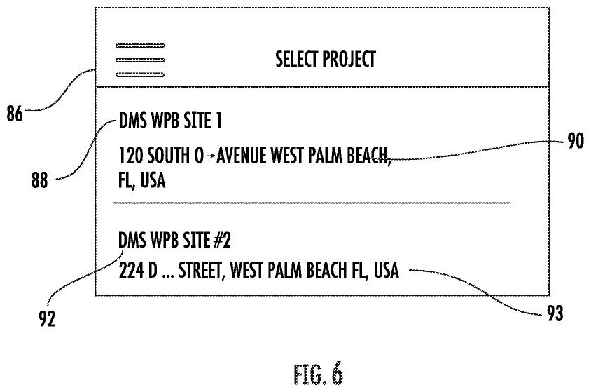

To access a particular jobsite, the user/employee (employee 1) accesses a menu screen 78, see menu screen shot 80 in FIG. 5. The menu screen 78 may be accessed by clicking on the three-line icon 82 in the top corner of the screen. By selecting the “Select Project” icon 84, location projects are shown, see screen shot 86, FIG. 6. As shown in FIG. 6, two projects are available for which employee 1 is eligible to clock in. Project No. One, 88, titled “DMS WPB Site No. 1” with an address line 90 providing the Project No. One, 88, location is shown. A second site, Project No. Two, 92, titled, “WPB Site No. 2, with an address line 93 providing the Project No. Two location is also shown. When the user/employee, in this case Employee 1, is ready to clock in to a particular job site, clicking on the Select Project icon from the menu provides a list of projects, i.e. Project No. One, 88, and Project No. Two, which they are in a geofence for and therefore eligible to clock in.

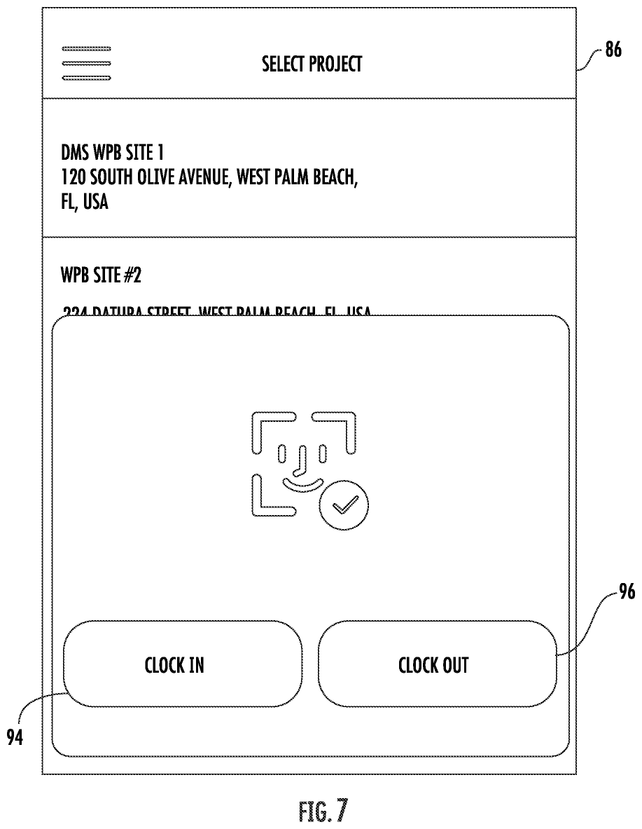

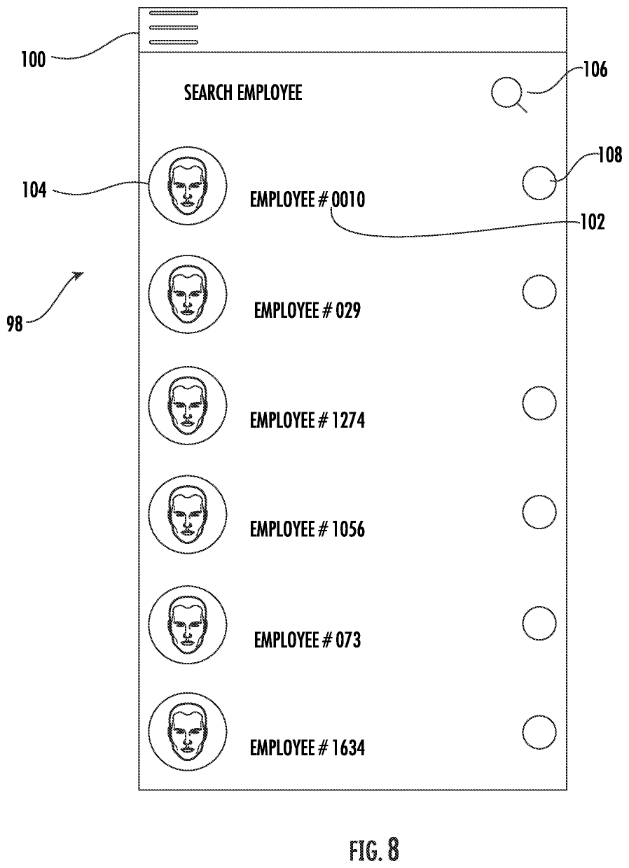

Once the user/employee clicks on the project site which he/she wants to clock into, the user/employee selects the “clock-in” icon 94, see FIG. 7. To clock out, the employee would engage the “clock-out” icon 96. After selecting the “clock-in” icon 94, an employee list 98 is shown, see employee list screen shot 100, FIG. 8. The employee list 98 is populated with all registered employees (or contractors, if needed) of the company. As shown, the employee list 98 contains the employee identification, shown as an employee number 102 and employee picture 104. The employee identification may also include the employee's name, not shown. An employee can scroll through the list or enter a name or employee number in the search box 106. Once found, the employee can select his/her name by selecting the corresponding selection circle 108. This process can be used to clock out as well.

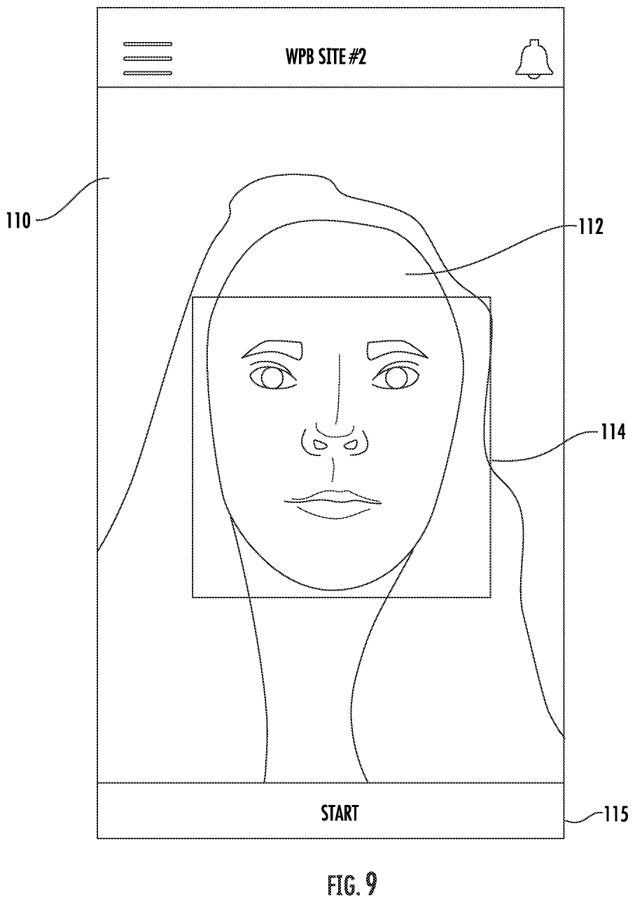

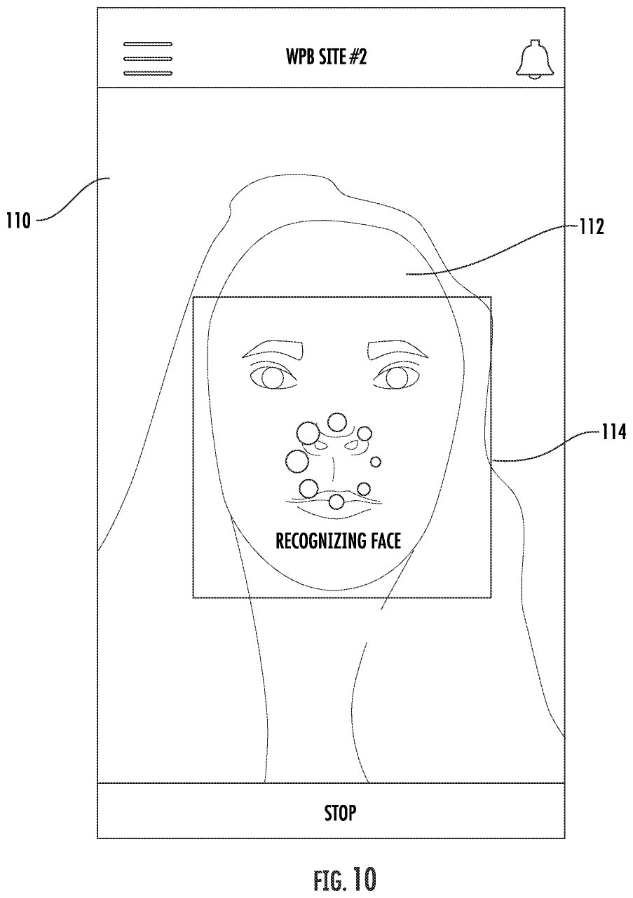

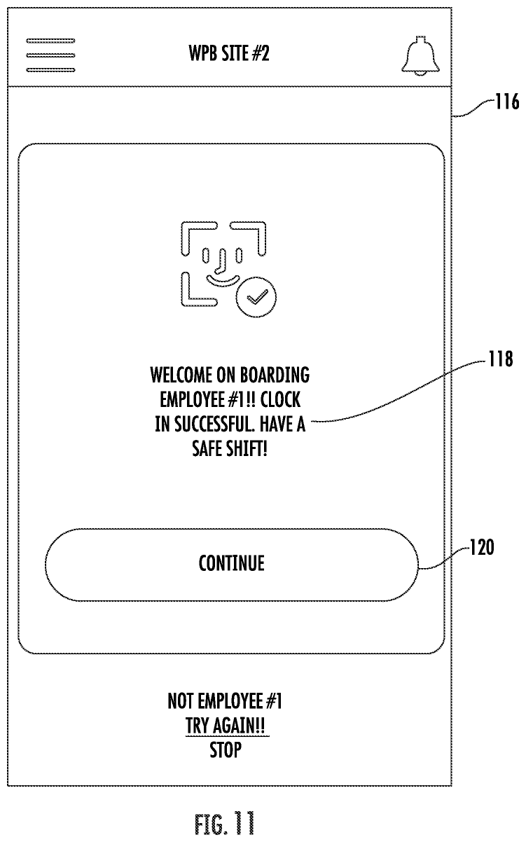

Once the user/employee selects his/her name for the clock-in, a verification process is started. In an illustrative embodiment, the user/employee verification process includes facial recognition, or other biometric recognition mechanisms, such as finger print, or iris scans. Referring to FIG. 9, a facial recognition screen 110 is illustrated. The facial recognition screen 110 allows the user/employee to take a picture of their face once a portion of the user/employee's face is placed within a shot box 114. Selecting the “START” icon 115 starts the facial recognition process, see FIG. 10. Once the picture of the user/employee matches their picture in a database and the user can be verified as the correct person, the user/employee has successfully clocked in, see FIG. 11. As shown on the registration confirmation screen shot 116, the user/employee is provided with a written message of clock-in success, 118, and allowed to continue the process by clicking on the “Continue” icon 120. If the user/employee is not the correct individual, an option to try again is provided. In an illustrative embodiment, the user/employee will be given two additional attempts to match before a manual clock option is presented.

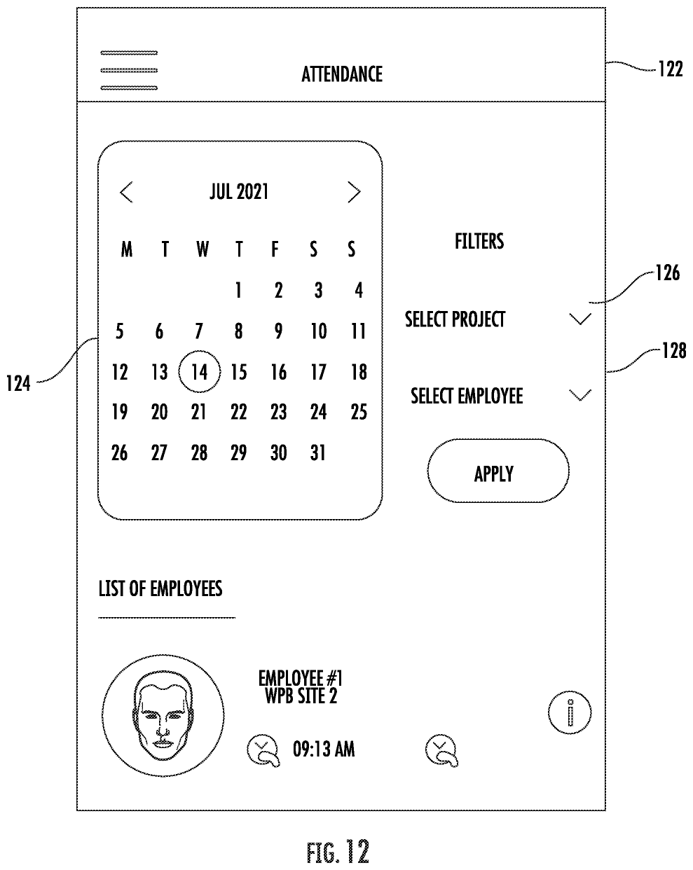

All clock-in data for each user/employee is stored and viewable by the user/employee or, more importantly, by the business owner or business management. FIG. 12 illustrates an attendance screen shot, 122. Using this feature, a manager can review all employees clocked into their particular projects/project sites on this screen. By clicking on a specific date on the calendar 124, or searching via a search icon for a selected project, 126, or an employee name 128, the manager can review all previous or current data obtained.

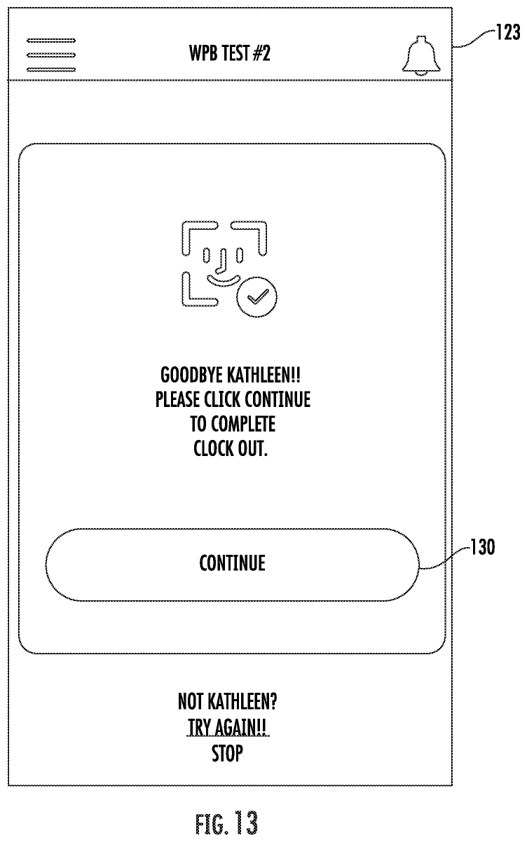

To clock out, the user/employee follows the same process of 1) selecting the project, 2) selecting their name from a list, and 3) verification by initialing the facial recognition. When the system matches the user/employee's photo, the user/employee can click on the “continue” icon 130 to clock out, see clock-out screen shot 130, FIG. 13. As part of the clock-out process, the employee tracking system 10, and method thereof, is configured to obtain additional employment related information from the user/employee.

Referring to FIG. 14, an illustrative embodiment of a first employment related activities screen shot 132 is shown. The first employment related activities screen shot 132 includes the site location 134, employee identification 136, clock-in time 138, and clock-out time 140. On the screen, the user is asked to, “Please select the cost code for the work performed in this shift.” in English 142 and a second language such as Spanish 144. A drop-down menu 146 provides various code numbers and associated work, see code “0196” for “supervision” 150. The user/employee may be asked: “Did you perform extra work in this shift (PCO or T&M), see 152. The user/employee may answer the question by using a yes/no toggle button, 154.

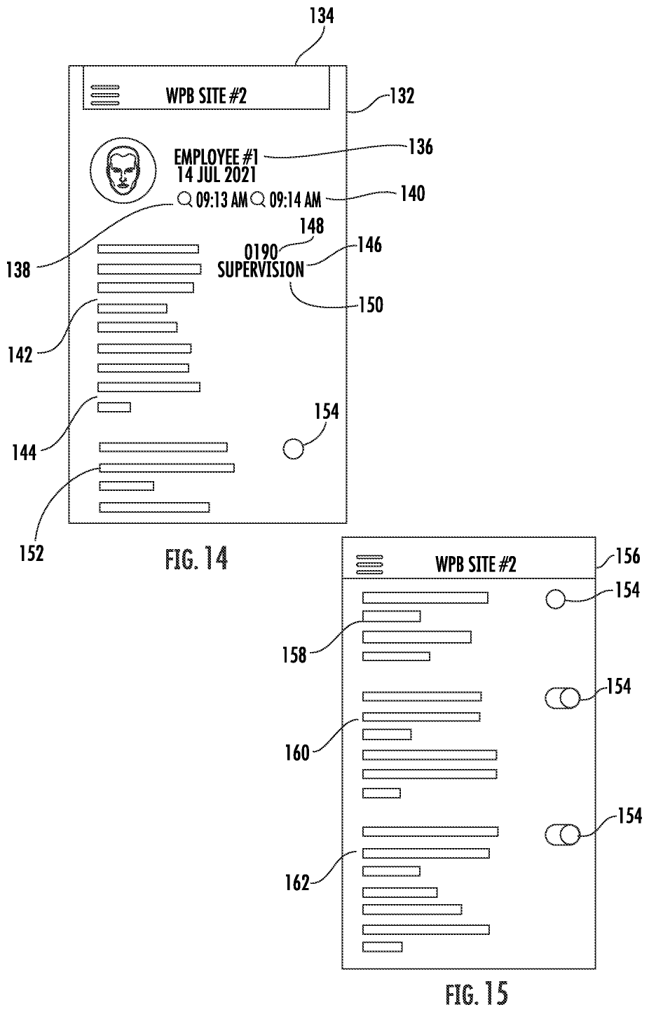

Referring to FIG. 15, an illustrative embodiment of a second employment related activities screen shot 156 is shown. On the screen, the user is asked to respond to the following questions:

1. “Where you injured on this shift”, 158;

2. “Was there sufficient water on site during this shift?”, 160;

3. “Did you receive your 10 minute breaks during this shift?”, 162.

Referring to FIG. 16, an illustrative embodiment of a third employment related activities screen shot 164 is shown. On the screen, the user is asked to respond to the following questions:

1. “Did you receive your 30-minute lunch today?”, 166;

2. “Where you harassed due to your race, color, religious creed, sex, national origin, ancestry, sexual orientation, age, marital status, gender identity or expression, medical condition, mental or physical disability or military veteran status?”, 168.

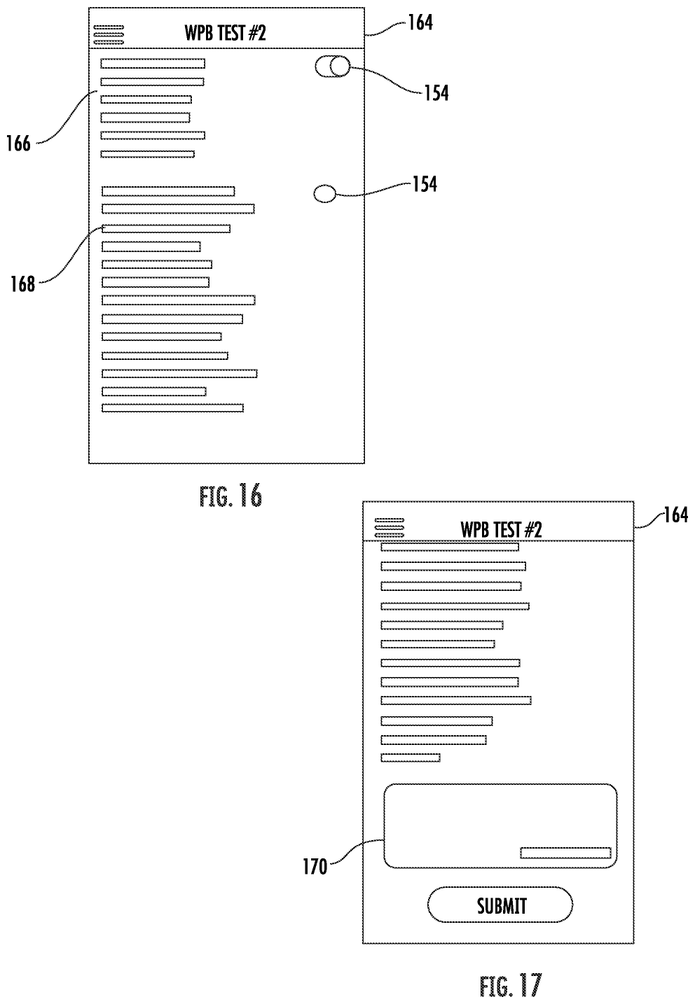

Any of the questions on the first employment related activities screen shot 132, the second employment related activities screen shot 156, or the third employment related activities screen shot 164 may also include an area for the user/employee to leave a message, see message box 170, FIG. 17. The user/employee may also be able to code any extra time for extra work. Finally, if a user/employee changes any of the Yes/No toggles 154, a message regarding such change may be sent via email or text message to Human Resources, or any other department or management personnel.

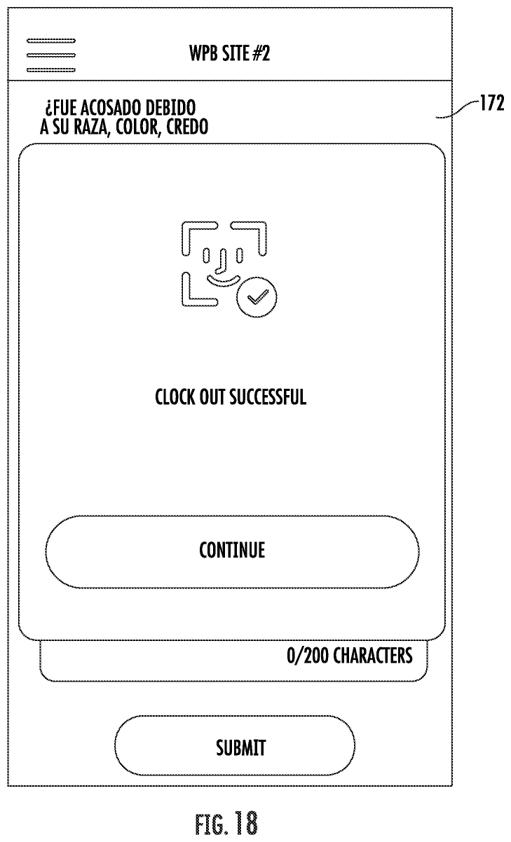

Once all questions have been answered by the user/employee, he/she will receive confirmation of a successful clock-out, see clock-out confirmation screen shot, 172, FIG. 18.

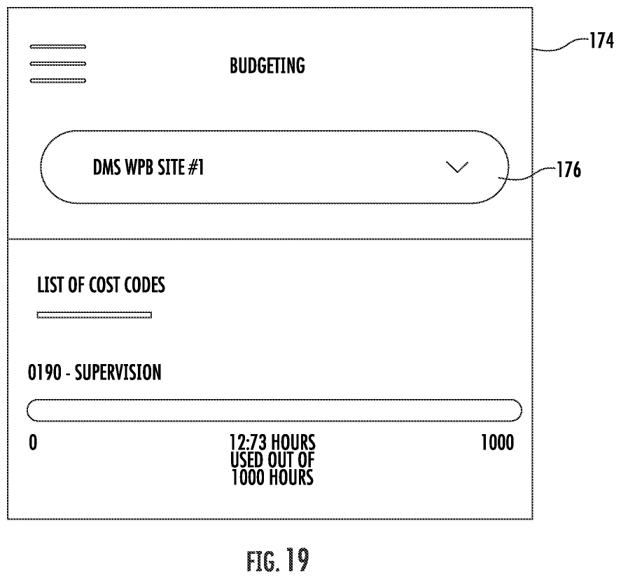

FIG. 19 illustrates a budget screen shot, 174. Using this feature, a manager can review all time entries by cost codes for each employee and for each work/job site. Using this feature, managers have the option to track how much time has been used on jobs based on how much time was budgeted per each cost code. This is a live, real-time value. Each time an employee clocks out and costs their time, this screen will be adjusted. By clicking on a drop-down menu 176, a manager can look at the various codes to see how much time has been spent on that task. For example, for code 0190-Supervision, a manager can view how many hours, and thus how much money has been allocated on that task. As shown in FIG. 19, the supervision hours were tasked at 1000 hours. Based on employee input, only 12.73 hours of the 1000 hours have been issued. By viewing this accounting, a manager can determine how much has already been spent and how much more money, per this code, needs to or can be spent. The employee tracking system 10 may be designed to include codes for each individual project or site. For examples, the codes may be designed to correspond with a company's estimate (i.e. time, costs, man hours) on a particular project and feed into other systems, such as payroll and accounting. Codes may be created for various tasks or jibs within a project, such as framing, drywalling, plaster, insulation, and may be depend on how many buildings, floors, areas associated with the project.

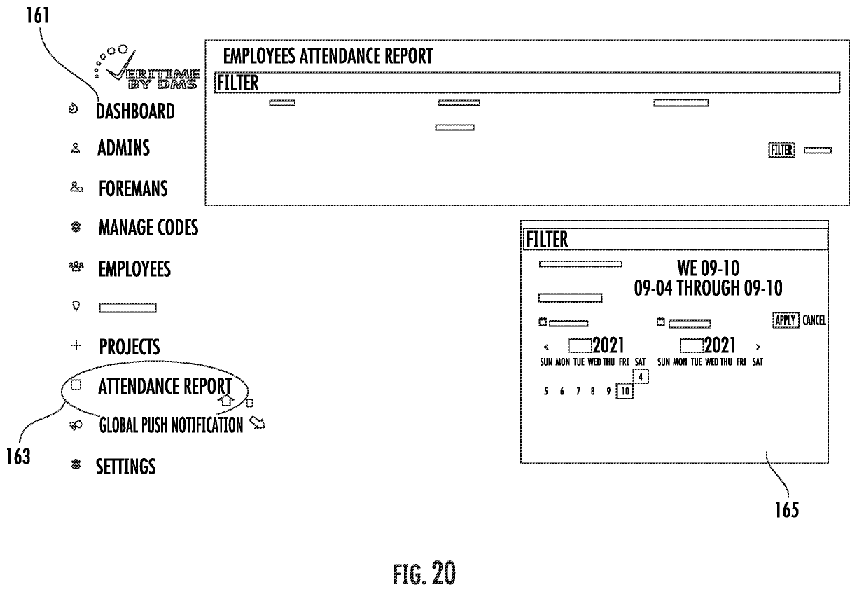

Any of the data obtained for each worker, i.e. all check-in/check-out times, hours worked, may be compiled and exported to other software programs, such as payroll or accounting. Such function will allow companies using the employee tracking system 10 to eliminate the use of tacking employee hours with time cards manually entered into payroll systems. Such capability not only saves time and reduces the manpower needed to accomplish such tasks, it also reduces the possibility of user related error. Employers may login to a data dashboard, (information management tool) 161, see FIG. 20 to obtain any data, such as attendance report 163, per employee and/or per project. The attendance report 163 may be used to pull the payroll clock in and out data. The data may be set per day or per date range of the payroll cycle, see calendar 165. The employer may filter any data to show any projects that are not to be included in the general payroll cycle. For example, any projects that are not using a specific set of funds from a specific cash account would need its own payroll cycle. All data obtained from the clock-ins/clock-outs from the specific data range and/or project selected can be displayed. The data displayed can then be exported, with the data automatically being downloaded to a file, such as an EXCEL file. The data exported can be loaded to other software programs, such as a company payroll software.

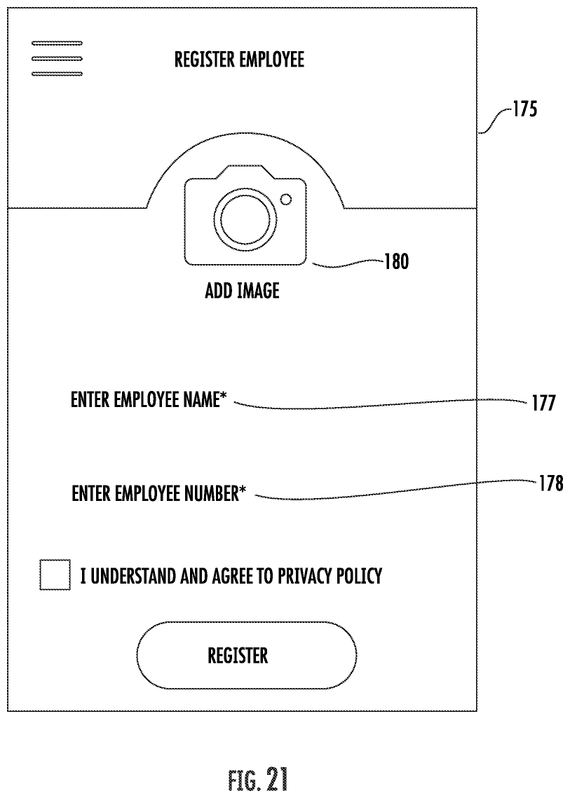

FIG. 21 illustrates the employee registration screen shot 175. Each user/employee will be required to register once. To register, the user/employee adds his/her name to an employee name input box 177 and his/her employee number to employee number input box 178. By clicking on the add image icon 180, a camera within the device takes photos of the user/employee's face. These pictures are used in the facial recognition process. In an illustrative example, fifty (50) photos of the user/employee's face can be taken and stored.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of electronically verifying and tracking one or more activities of an individual within a worksite, comprising:
establishing an electronic connection with an electronic tracking device used by an individual requiring verification and tracking within a worksite;
identifying said individual requiring verification and tracking within a worksite;
verifying said individual requiring verification and tracking is located at or within a predetermined area near said worksite;
verifying an identity of said individual requiring verification and tracking;
obtaining data related to at least one or more employment activities of said individual requiring verification and tracking within a worksite while located at or within a predetermined area near said worksite.

2. The method of electronically verifying and tracking one or more activities of an individual within a worksite according to claim 1, wherein data is obtained relating to the time said individual requiring verification and tracking within a worksite is located at said worksite.

3. The method of electronically verifying and tracking one or more activities of an individual within a worksite according to claim 2, wherein said data obtained is sent to a third party.

4. The method of electronically verifying and tracking one or more activities of an individual within a worksite according to claim 1, wherein data is obtained relating to:
1) if said individual requiring verification and tracking within a worksite was injured during any time while working on said jobsite;
2) if said individual requiring verification and tracking within a worksite was allowed to obtain water or other liquids while working on said jobsite;
3) if said individual requiring verification and tracking within a worksite was allowed a predetermined amount of time to rest while working on said jobsite;
4) if said individual requiring verification and tracking within a worksite was allowed a predetermined time to eat lunch while working on said jobsite;
5, if said individual requiring verification and tracking within a worksite was harassed due to race, color, religious creed, sex, national origin, ancestry, sexual orientation, age, marital status, gender identity or expression, medical condition, mental or physical disability, military veteran status, or combinations thereof; or
6) any combination of 1-5.

5. The method of electronically verifying and tracking one or more activities of an individual within a worksite according to claim 4, wherein said data obtained is sent to a third party.

6. The method of electronically verifying and tracking one or more activities of an individual within a worksite according to claim 1, wherein said step of verifying an identity of said individual requiring verification and tracking comprises a facial recognition process comprising the steps of:
obtaining one or more photograph(s) of said individual requiring verification and tracking within a worksite; and
electronically comparing said one or more photographs of said individual requiring verification and tracking within a worksite to a database having one or more stored photographs of said individual requiring verification and tracking within a worksite.

7. The method of electronically verifying and tracking one or more activities of an individual within a worksite according to claim 1, wherein said step of verifying said individual requiring verification and tracking is located at or within a predetermined area near said worksite comprises:
electronically defining said worksite through a geofence;
obtaining said positioning of said electronic tracking device used by said individual requiring verification and tracking within a worksite; and
confirming said electronic tracking device used by said individual requiring verification and tracking within a worksite is within said geofence area.

8. The method of electronically verifying and tracking one or more activities of an individual within a worksite according to claim 1, further including a clock-out process, comprising:
establishing a second electronic connection with said electronic tracking device used by said individual requiring verification and tracking within a worksite;
identifying said individual requiring verification and tracking within a worksite;
verifying said individual requiring verification and tracking is located at or within said predetermined area near said worksite; and
verifying said identity of said individual requiring verification and tracking.

9. The method of electronically verifying and tracking one or more activities of an individual within a worksite according to claim 1, wherein said data obtained relating to said one or more activities of an individual within a worksite is coded, said coding based on categories of activities.

10. The method of electronically verifying and tracking one or more activities of an individual within a worksite according to claim 1, wherein said data obtained includes multiple individuals within said worksite.

11. A non-transitory computer readable medium having computer readable instructions embodied thereon for electronically verifying and tracking one or more activities of an individual within a worksite, wherein, when executed by at least one processor of an electronic tracking device used by said individual requiring verification and tracking within a worksite, the computer-executable instructions cause at least one processor to at least perform operations comprising:
establishing an electronic connection with an electronic tracking device used by an individual requiring verification and tracking within a worksite;
identifying said individual requiring verification and tracking within a worksite;
verifying said individual requiring verification and tracking is located at or within a predetermined area near said worksite;
verifying an identity of said individual requiring verification and tracking; and
obtaining data related to at least one or more employment activities of said individual requiring verification and tracking within a worksite while located at or within a predetermined area near said worksite.

12. The non-transitory computer readable medium according to claim 11, wherein data is obtained relating to the time said individual requiring verification and tracking within a worksite is located at said worksite.

13. The non-transitory computer readable medium according to claim 11, wherein data is obtained relating to:
1) if said individual requiring verification and tracking within a worksite was injured during any time while working on said jobsite;
2) if said individual requiring verification and tracking within a worksite was allowed to obtain water or other liquids while working on said jobsite;
3) if said individual requiring verification and tracking within a worksite was allowed a predetermined amount of time to rest while working on said jobsite;
4) if said individual requiring verification and tracking within a worksite was allowed a predetermined time to eat lunch while working on said jobsite;
5, if said individual requiring verification and tracking within a worksite was harassed due to race, color, religious creed, sex, national origin, ancestry, sexual orientation, age, marital status, gender identity or expression, medical condition, mental or physical disability, military veteran status, or combinations thereof; or
6) any combination of 1-5.

14. The non-transitory computer readable medium according to claim 11, wherein said step of verifying an identity of said individual requiring verification and tracking comprises a facial recognition process comprising a facial recognition process comprising the steps of:
obtaining one or more photographs of said individual requiring verification and tracking within a worksite; and
electronically comparing said one or more photographs of said individual requiring verification and tracking within a worksite to a database having one or more stored photographs of said individual requiring verification and tracking within a worksite.

15. The non-transitory computer readable medium according to claim 11, wherein said step of verifying said individual requiring verification and tracking is located at or within a predetermined area near said worksite comprises:
electronically defining said worksite through a geofence;
obtaining said positioning of said electronic tracking device used by said individual requiring verification and tracking within a worksite; and
confirming said electronic tracking device used by said individual requiring verification and tracking within a worksite is within said geofence area.

16. The non-transitory computer readable medium according to claim 11, further including a clock-out process, comprising:
establishing a second electronic connection with said electronic tracking device used by said individual requiring verification and tracking within a worksite;
identifying said individual requiring verification and tracking within a worksite;
verifying said individual requiring verification and tracking is located at or within said predetermined area near said worksite; and
verifying said identity of said individual requiring verification and tracking.

17. A system for electronically verifying and tracking one or more activities of an individual within a worksite comprising an electronic device, a processor operable to execute instructions and a data storage medium for storing instructions which, when executed by the processor, cause the processor to:
identify said individual requiring verification and tracking within a worksite;
verify said individual requiring verification and tracking is located at or within a predetermined area near said worksite;
verify an identity of said individual requiring verification and tracking;
obtain data related to at least one or more employment activities of said individual requiring verification and tracking within a worksite while located at or within a predetermined area near said worksite.

18. The system for electronically verifying and tracking one or more activities of an individual within a worksite according to claim 17, within said processor, further comprises a clock-out process.

19. The system for electronically verifying and tracking one or more activities of an individual within a worksite according to claim 17, wherein said step of verifying an identity of said individual requiring verification and tracking comprises the steps of:
obtaining one or more photographs of said individual requiring verification and tracking within a worksite; and
electronically comparing said one or more photographs of said individual requiring verification and tracking within a worksite to a database having one or more stored photographs of said individual requiring verification and tracking within a worksite.

20. The system for electronically verifying and tracking one or more activities of an individual within a worksite according to claim 17, wherein said step of verifying said individual requiring verification and tracking is located at or within a predetermined area near said worksite comprises:
electronically defining said worksite through a geofence;
obtaining said positioning of said electronic device used by said individual requiring verification and tracking within a worksite; and
confirming said electronic device used by said individual requiring verification and tracking within a worksite is within said geofence area.
